(19) United States
(12) Patent Application Publication
(10) Pub. No.: US 2016/0059464 A1
(43) Pub. Date: Mar. 3, 2016

(54) MOLDABLE CAPSULE AND METHOD OF MANUFACTURE

(71) Applicant: INTEGRAL TECHNOLOGIES, INC., Bellingham, WA (US)

(72) Inventor: MO ZEIDAN, BLOOMFIELD HILLS, MI (US)

(21) Appl. No.: 14/926,796

(22) Filed: Oct. 29, 2015

Related U.S. Application Data
(63) Continuation of application No. 13/842,541, filed on Mar. 15, 2013, now abandoned.

(51) Int. Cl. B29C 47/02; B29C 47/88; B29C 47/00

(52) U.S. Cl. CPC B29C 47/027; B29C 47/0016; B29C 47/0066; B29C 47/8815; B29K 2101/00

(57) ABSTRACT

A method to form moldable capsules of a conductively doped resin-based material are created. A resin-based material is extruded/pultruded onto a bundle of conductive material. The resin-based material and the bundle are sectioned into moldable capsules.

### RELATED APPLICATIONS

This patent application is a continuation of U.S. patent application Ser. No. 13/842,541, filed on Mar. 15, 2013, which is herein incorporated by reference in its entirety.

### FIELD OF THE INVENTION

This invention relates to conductive polymers and, more particularly, to conductively doped resin-based materials for molding comprising micron conductive powders, micron conductive fibers, or a combination thereof, substantially homogenized within a base resin when molded. Even more particularly, this invention relates to a moldable capsule, and a method for forming such a moldable capsule, wherein this moldable capsule is useful for molding conductive articles.

### BACKGROUND OF THE INVENTION

Resin-based polymer materials are used for the manufacture of a wide array of articles. These polymer materials combine many outstanding characteristics, such as excellent strength to weight ratio, corrosion resistance, electrical isolation, and the like, with an ease of manufacture using a variety of well-established molding processes. Many resin-based polymer materials have been introduced into the market to provide useful combinations of characteristics.

In spite of many outstanding characteristics, resin-based polymer materials are unfortunately, typically poor conductors of thermal and electrical energy. Low thermal conductivity can be an advantageous in applications where insulators are desired. In other cases, however, resin-based materials known as insulators conduct thermal or electrical energy poorly and are not useful. Where high thermal or electrical conductivity is required, conductive metals, such as copper or aluminum or other metals, are typically used. A disadvantage of solid metal conductors is the density of these materials. For an example in electrical and thermal applications such as used in aircraft, satellites, vehicles, or even in hand held devices the weight due to solid metal conductors is significant. It is therefore desirable to replace solid metal conductors with less dense materials. Since resin-based materials are typically much less dense than metals, and can have the strength of metals, these materials would theoretically be good replacements for metals. However, the problems of low conductivity must be resolved.

Attempts have been made in the art to create thermally and electrically conductive resin-based materials. There are two general classifications of such materials, intrinsically conductive and non-intrinsically conductive. Intrinsically conductive resin-based materials, which may also be referred to as conjugated resins, incorporate complex carbon molecule bonding within the polymer, increasing the conductivity of the material. Unfortunately, intrinsically conductive resin-based materials typically are difficult to manufacture, very expensive and are limited in conductivity. Non-intrinsically conductive resin-based materials, which also may be referred to as doped materials, are formed by mixing conductive fillers or dopants, such as conductive fibers, powders, or combinations thereof, within a base resin materials, resulting in increased conductivity in a molded form. Metallic and non-metallic fillers have been demonstrated in the art to provide substantially increased conductivity in a composite material while maintaining competitive cost.

It is a primary objective of the present invention to provide a moldable capsule that effectively time releases the conductive filler during the mixing cycle during molding, and substantially homogenizes the conductive dopant within the resulting base resin polymer matrix.

### SUMMARY OF THE INVENTION

Certain embodiments of the present invention include a method to form a moldable capsule comprising providing a bundle of conductive fiber, heating the bundle, depositing a resin-based material onto the bundle to form a composite strand, and sectioning the composite strand into moldable capsules.

In some embodiments, heating comprises heating the bundle to a temperature near the melt temperature of the resin-based material. In other embodiments, heating comprises heating the bundle to a temperature above the melt temperature of the resin-based material. In further embodiments, heating comprises heating the bundle to a temperature above the glass transition temperature of the resin-based material.

In certain embodiments, heating comprises routing the bundle through a heater. In other embodiments, the heater is selected from the group consisting of a convection heater, a radiant heater, a conductive heater, and combinations of any thereof. In certain of these embodiments, depositing comprises pulling the bundle through a crosshead die.

In some embodiments, the resin-based material comprises a substantially homogeneous mixture of a micron conductive material. In other embodiments, the conductive fiber of the invention is a micron conductive fiber. In further embodiments, the micron conductive fiber comprises between about 5% and about 50% of the total weight of each of the moldable capsules. In still other embodiments, the micron conductive fiber comprises a material selected from the group consisting of a metal or metal alloy, a non-conductive inner core material with outer conductive plating, a ferromagnetic material, and combinations of any thereof. In further embodiments, the micron fiber has a diameter of approximately 3 to 12 microns and a length of approximately 2 to 14 mm.

Certain embodiments of the present invention include a method to form a moldable capsule comprising providing a bundle of conductive fiber, depositing a resin-based material onto the bundle to form a composite strand, performing a wetting process on the composite strand, and sectioning the composite strand into moldable capsules. In certain embodiments, performing a wetting process comprises exerting a force on the outside of the strand. In some embodiments, exerting the force comprises at least one roller.

In some embodiments, the strand is cooled before exerting the force. In other embodiments, an outer portion of the strand is cooled to a temperature below the melting point before exerting the force. In still other embodiments, an outer portion of the strand is cooled to a temperature near the glass transition temperature before exerting a force. In further embodiments, an outer portion of the strand is cooled to a temperature below the glass transition temperature before exerting the force. And in still further embodiments, a secondary portion of the capsule between the outer portion and the bundle is at a temperature wherein the resin in the secondary portion will flow under the force when exerting the force.

In some embodiments, depositing comprises pulling the bundle through a cross-head die. In further embodiments include heating the bundle prior to depositing. Still further embodiments include wherein exerting a force and sectioning are performed in substantially the same operation.

In certain embodiments, the conductive fiber is a micron conductive fiber. In other embodiments, the micron conductive fiber comprises between about 5% and about 50% of the total weight of each the moldable capsule. In still further embodiments, the micron conductive fiber comprises a material selected from the group consisting of a metal or metal alloy, a non-conductive inner core material with outer conductive plating, a ferromagnetic material, and combinations of any thereof. In other embodiments, the micron fiber has a diameter of approximately 3 to 12 microns and a length of approximately 2 to 14 mm.

Certain embodiments of the present invention include a capsule made by the process of exerting a force on the strand after depositing resin on the fiber bundle to form the strand. In certain embodiments, the capsule and an inner fiber bundle comprise a non-circular profile.

Certain embodiments of the present invention include a moldable capsule, comprising an inner bundle of conductive fiber, and an outer layer of resin, wherein the capsule and inner fiber bundle comprise a non-circular profile. In some embodiments, the non-circular profile is selected from the group consisting of substantially oval, substantially rectangular, and combinations of any thereof. In still other embodiments, the non-circular profile of the bundle is selected from the group consisting of substantially oval, substantially rectangular, substantially a figure-eight, and combinations of any thereof.

### BRIEF DESCRIPTION OF THE DRAWINGS

In the accompanying drawings forming a material part of this description, there is shown:

FIG. 1 illustrates a first embodiment of the present invention showing a method to manufacture a moldable capsule.

FIG. 2 illustrates a first embodiment of a conductively doped resin-based material wherein the conductive materials comprise a powder.

FIG. 3 illustrates a second embodiment of a conductively doped resin-based material wherein the conductive materials comprise micron conductive fibers.

FIG. 4 illustrates a third embodiment of a conductively doped resin-based material wherein the conductive materials comprise both conductive powder and micron conductive fibers.

FIGS. 5a and 5b illustrate a fourth embodiment wherein conductive fabric-like materials are formed from the conductively doped resin-based material.

FIGS. 6a and 6b illustrate, in simplified schematic form, an injection molding apparatus and an extrusion molding apparatus that may be used to mold articles of a conductively doped resin-based material.

FIG. 7 illustrates a second embodiment of the present invention showing a crosshead extrusion die of the present invention.

FIG. 8 illustrates a third embodiment of the present invention showing a moldable capsule of the present invention.

FIG. 9 illustrates a fourth embodiment of the present invention showing an extruder system for forming the moldable capsule.

FIG. 10 illustrates a fifth embodiment of the present invention showing an extruder system for forming the moldable capsule where chopped fiber is added to the resin-based extrusion material.

FIG. 11 illustrates a sixth embodiment of the present invention showing an extruder system for forming the moldable capsule where fiber is blown into the resin-based extrusion material.

### DETAILED DESCRIPTION

Numbers in the present disclosure are rounded to the nearest significant figure using conventional rounding techniques. Ranges of numbers contained herein are understood to contain the numbers on the upper and lower limits, unless otherwise indicated. For instance, a range “from 1 to 10” is understood to include a range including the number “1,” and up to and including the number “10.”

The present invention relates to conductively doped resin-based materials comprising micron conductive powders, micron conductive fibers, or a combination thereof, substantially homogenized within a base resin when molded. More particularly, the present invention relates to moldable capsules comprising a conductively doped material and a resin-based material that are useful in the manufacture of articles made from conductively doped resin-based materials.

The conductively doped resin-based materials of the invention are base resins doped with conductive materials, which then transforms any base resin into a conductor rather than an insulator. The resins provide the structural integrity to the molded part. The micron conductive fibers, micron conductive powders, or a combination thereof, are substantially homogenized within the base resin during the molding process, providing the electrical, thermal, and acoustical continuity.

The conductively doped resin-based materials can be molded, extruded or the like to provide almost any desired shape or size. The molded conductively doped resin-based materials can also be cut, stamped, or vacuumed formed from an injection molded or extruded sheet or bar stock, over-molded, laminated, milled, or the like, to provide the desired shape and size. The thermal, electrical, and acoustical continuity and or conductivity characteristics of articles or parts fabricated using conductively doped resin-based materials depends on the composition of the conductively doped resin-based materials, of which the doping parameters and or materials can be adjusted, to aid in achieving the desired structural, electrical or other physical characteristics of the then molded material. The selected materials used to fabricate the articles are first made into a capsule as described herein, and then are substantially homogenized together using molding techniques and or methods such as injection molding, over-molding, insert molding, compression molding, thermo-set, protrusion, extrusion, calendaring, or the like. Characteristics related to 2D, 3D, 4D, and 5D designs, molding and electrical characteristics, include the physical and electrical advantages that can be achieved during the molding process of the actual parts and the molecular polymer physics associated within the conductive networks within the molded part(s) or formed material(s).

In the conductively doped resin-based material, electrons travel from point to point, following the path of least resistance. Most resin-based materials are insulators and represent a high resistance to electron passage. The doping within the resin-based material alters the inherent resistance of the polymers. At a threshold concentration of conductively doping, the resistance through the combined mass is lowered enough to allow electrons movement. Speed of electron movement depends on conductive doping concentration and the materials chemical makeup, that is, the separation between the conductive doping particles. Increasing conductive doping content reduces interparticle separation distance, and, at a critical distance known as the percolation point, resistance decreases dramatically and free electrons move rapidly.

Resistivity is a material property that depends on the atomic bonding of the microstructure of the material. The atomic microstructure material properties within the conductively doped resin-based material are altered when a capsule as described herein is molded into a structure. A substantially homogenized conductive microstructure of delocalized valance electrons is created within the valance and conduction bands of the said molecules. This microstructure provides sufficient charge carriers within the molded matrix structure. As a result, a low density, low resistivity, lightweight, durable, resin based polymer microstructure material is achieved. This material can exhibit conductivity comparable to that of highly conductive metals such as silver, copper or aluminum, while maintaining the superior structural characteristics found in many plastics and rubbers or other structural resin based materials.

The use of conductively doped resin-based materials in the fabrication of articles and parts significantly lowers the cost of materials and the design and manufacturing processes used to hold ease of close tolerances, by forming these materials into desired shapes and sizes. The articles can be manufactured into infinite shapes and sizes using conventional forming and molding methods such as injection molding, over-molding, compression molding, thermoset molding, or extrusion, calendaring, or the like. The conductively doped resin-based materials, when molded, typically but not exclusively produce a desirable usable range of resistivity of less than about 5 to more than about 25 ohms per square, but other resistivities can be achieved by varying the dopants, doping parameters, and/or base resin selection(s).

The capsule as described herein comprises conductively doped resin-based materials and a conductive material, for example, micron conductive powders, micron conductive fibers, or any combination thereof. The capsules are substantially homogenized together within the base resin during the molding process, yielding an easy to produce low cost, electrical, thermal, and acoustical performing article. The resulting molded article comprises a three dimensional, continuous capillary network of conductive doping particles contained and/or bonding within the polymer matrix.

### Conductive Powders

Exemplary micron conductive powders include carbons, graphites, amines, eeonomers, or the like, and/or metal powders such as nickel, copper, silver, aluminum, nichrome, various plated materials or the like. The use of carbons or other forms of powders such as graphite(s) etc. can create additional low level electron exchange and, when used in combination with micron conductive fibers, creates a micron filler element within the micron conductive network of fiber(s) producing further electrical conductivity as well as acting as a lubricant for the molding equipment. Carbon nano-tubes may be added to the conductively doped resin-based material. The addition of conductive powder to the micron conductive fiber doping may improve the electrical continuity on the surface of the molded part to offset any skinning effect that occurs during molding.

### Conductive Fibers

The micron conductive fibers may be metal fiber or metal plated fiber. Further, the metal plated fiber may be formed by plating metal onto a metal fiber or by plating metal onto a non-metal fiber. Exemplary metal fibers include, but are not limited to, stainless steel fiber, copper fiber, nickel fiber, silver fiber, aluminum fiber, nichrome fiber, or the like, or combinations thereof. Exemplary metal plating materials include, but are not limited to, copper, nickel, cobalt, silver, gold, palladium, platinum, ruthenium, rhodium, and nichrome, and alloys of thereof. Any platable fiber may be used as the core for a plated non-metal fiber. Exemplary non-metal fibers include, but are not limited to, carbon, graphite, polyester, basalt, melamine, man-made and naturally-occurring materials, and the like. In addition, superconductor metals, such as titanium, nickel, niobium, and zirconium, and alloys of titanium, nickel, niobium, and zirconium may also be used as micron conductive fibers and/or as metal plating onto fibers in the present invention.

In one embodiment, the fibers may have diameters of between about 3 and 12 microns, in other embodiments between about 6 and 12 microns or in still further embodiments in the range of about 10 microns, with length(s) that can be seamless or overlapping. In some embodiments, the length of the fibers is between about 2 and 14 millimeters. In other embodiments, the length of the fibers is between about 4 and 6 millimeters, or in still further embodiments about 8 millimeters.

Where micron fiber is combined with base resin, the micron fiber may be pretreated to improve performance. According to one embodiment of the present invention, conductive or non-conductive powders are leached into the fibers prior to extrusion. In other embodiments, the fibers are subjected to any or several chemical modifications in order to improve the fibers interfacial properties. Fiber modification processes include, but are not limited to: chemically inert coupling agents; gas plasma treatment; anodizing; mercerization; peroxide treatment; benzoylation; or other chemical or polymer treatments.

Chemically inert coupling agents are materials that are molecularly bonded onto the surface of metal and or other fibers to provide surface coupling, mechanical interlocking, inter-diffusion and adsorption and surface reaction for later bonding and wetting within the resin-based material. This chemically inert coupling agent does not react with the resin-based material. An exemplary chemically inert coupling agent is silane. In a silane treatment, silicon-based molecules from the silane bond to the surface of metal fibers to form a silicon layer. The silicon layer bonds well with the subsequently extruded resin-based material yet does not react with the resin-based material. As an additional feature during a silane treatment, oxane bonds with any water molecules on the fiber surface to thereby eliminate water from the fiber strands. Silane, amino, and silane-amino are three exemplary pre-extrusion treatments for forming chemically inert coupling agents on the fiber.

In a gas plasma treatment, the surfaces of the metal fibers are etched at atomic depths to re-engineer the surface. Cold temperature gas plasma sources, such as oxygen and ammonia, are useful for performing a surface etch prior to extrusion. In one embodiment of the present invention, gas plasma treatment is first performed to etch the surfaces of the fiber strands. A silane bath coating is then performed to form a chemically inert silicon-based film onto the fiber strands. In another embodiment, metal fiber is anodized to form a metal oxide over the fiber. The fiber modification processes described herein are useful for improving interfacial adhesion, improving wetting during homogenization, and/or reducing oxide growth (when compared to non-treated fiber). Pretreatment fiber modification also reduces levels of particle dust, fines, and fiber release during subsequent capsule sectioning, cutting or vacuum line feeding.

### Resin-Based Materials

The resin-based structural material may be any polymer resin or combination of compatible polymer resins. Non-conductive resins or inherently conductive resins may be used as the structural material. Conjugated polymer resins, complex polymer resins, and/or inherently conductive resins may be used as the structural material. The dielectric properties of the resin-based material will have a direct effect upon the final electrical performance of the conductively doped resin-based material. Many different dielectric properties are possible depending on the chemical makeup and/or arrangement, such as linking, cross-linking or the like, of the polymer, co-polymer, monomer, ter-polymer, or homo-polymer material. The resin-based materials may be, for example, thermoplastics or thermosets. Examples of thermoplastics include, but are not limited to acrylics, cellulosics, fluoroplastics, ionomers, polyamides, polycarbonates, polyetheretherketones, polyetherimides, polyesters, polyimides, polyolefins, polystyrenes, polysulfones, polyvinyls, and the like. Examples of thermosets include, but are not limited to, alkyds, allylics, epoxies, phenolics, polyesters, polyimides, polyurethanes, and silicones.

The capsules described herein, resin-based structural material doped with micron conductive powders, micron conductive fibers, or in combination thereof, can be molded using conventional molding methods such as injection molding or over-molding, or extrusion to create desired shapes and sizes. The molded conductively doped resin-based materials can also be stamped, cut or milled as desired to form create the desired shapes and form factor(s). The doping composition and directionality associated with the micron conductors within the doped base resins can affect the electrical and structural characteristics of the articles and can be precisely controlled by mold designs, gating and or protrusion design(s) and or during the molding process itself. In addition, the resin base can be selected to obtain the desired thermal characteristics such as very high melting point or specific thermal conductivity.

A resin-based sandwich laminate could also be fabricated with random or continuous webbed micron stainless steel fibers or other conductive fibers, forming a cloth like material. The webbed conductive fiber can be laminated or the like to materials such as Teflon, polyesters, or any resin-based flexible or solid material(s), which when discretely designed in fiber content(s), orientation(s) and shape(s), will produce a very highly conductive flexible cloth-like material. Such a cloth-like material could also be used in forming articles that could be embedded in a person's clothing as well as other resin materials such as rubber(s) or plastic(s).

The conductively doped resin-based material may also be formed into a prepreg laminate, cloth, or webbing. A laminate, cloth, or webbing of the conductively doped resin-based material is first homogenized with a resin-based material. In various embodiments, the conductively doped resin-based material is dipped, coated, sprayed, and/or extruded with resin-based material to cause the laminate, cloth, or webbing to adhere together in a prepreg grouping that is easy to handle. This prepreg is placed, or laid up, onto a form and is then heated to form a permanent bond. In another embodiment, the prepreg is laid up onto the impregnating resin while the resin is still wet and is then cured by heating or other means. In another embodiment, the wet lay-up is performed by laminating the conductively doped resin-based prepreg over a honeycomb structure. In another embodiment, the honeycomb structure is made from conductively doped, resin-based material. In yet another embodiment, a wet prepreg is formed by spraying, dipping, or coating the conductively doped resin-based material laminate, cloth, or webbing in high temperature capable paint.

### Combinations of Resin-Based Materials and Conductive Materials

Prior art carbon fiber and resin-based composites are found to display unpredictable points of failure. In carbon fiber systems there is little if any elongation of the structure. By comparison, in the present invention, the conductively doped resin-based material, even if formed with carbon fiber or metal plated carbon fiber, displays greater strength of the mechanical structure due to the substantial homogenization of the fiber created by the moldable capsules. As a result a structure formed of the conductively doped resin-based material of the present invention will maintain structurally even if crushed while a comparable carbon fiber composite will break into pieces.

The conductively doped resin-based material of the present invention can be made resistant to corrosion and/or metal electrolysis by selecting micron conductive fiber and/or micron conductive powder dopants and base resins that are resistant to corrosion and/or metal electrolysis. For example, if a corrosion/electrolysis resistant base resin is combined with fibers/powders or in combination of such as stainless steel fiber, inert chemical treated coupling agent warding against corrosive fibers such as copper, silver and gold and or carbon fibers/powders, then corrosion and/or metal electrolysis resistant conductively doped resin-based material is achieved. Another additional and important feature of the present invention is that the conductively doped resin-based material of the present invention may be made flame retardant. Selection of a flame-retardant (FR) base resin material allows the resulting product to exhibit flame retardant capability. This is especially important in applications as described herein.

The substantially homogeneous mixing of micron conductive fiber and/or micron conductive powder and base resin described in the present invention may also be described as doping. That is, the substantially homogeneous mixing transforms a typically non-conductive base resin material into a conductive material. This process is analogous to the doping process whereby a semiconductor material, such as silicon, can be converted into a conductive material through the introduction of donor/acceptor ions as is well known in the art of semiconductor devices. Therefore, the present invention uses the term doping to mean converting a typically non-conductive base resin material into a conductive material through the substantially homogeneous mixing of micron conductive fiber and/or micron conductive powder within a base resin.

As an additional and important feature of the present invention, the molded conductor doped resin-based material exhibits excellent thermal dissipation characteristics. Therefore, articles manufactured from the molded conductor doped resin-based material can provide added thermal dissipation capabilities to the application. For example, heat can be dissipated from electrical devices physically and/or electrically connected to an article of the present invention.

As a significant advantage of the present invention, articles constructed of the conductively doped resin-based material can be easily interfaced to an electrical circuit or grounded. In one embodiment, a wire can be attached to conductively doped resin-based articles via a screw that is fastened to the article. For example, a simple sheet-metal type, self-tapping screw can, when fastened to the material, can achieve excellent electrical connectivity via the conductive matrix of the conductively doped resin-based material. To facilitate this approach a boss may be molded as part of the conductively doped resin-based material to accommodate such a screw. Alternatively, if a solderable screw material, such as copper, is used, then a wire can be soldered to the screw is embedded into the conductively doped resin-based material. In another embodiment, the conductively doped resin-based material is partly or completely plated with a metal layer. The metal layer forms excellent electrical conductivity with the conductive matrix. A connection of this metal layer to another circuit or to ground is then made. For example, if the metal layer is solderable, then a soldered connection may be made between the article and a grounding wire.

Where a metal layer is formed over the surface of the conductively doped resin-based material, any of several techniques may be used to form this metal layer. This metal layer may be used for visual enhancement of the molded conductively doped resin-based material article or to otherwise alter performance properties. Well-known techniques, such as electroless metal plating, electro plating, electrolytic metal plating, sputtering, metal vapor deposition, metallic painting, or the like, may be applied to the formation of this metal layer. If metal plating is used, then the resin-based structural material of the conductively doped, resin-based material is one that can be metal plated. There are many of the polymer resins that can be plated with metal layers. Electroless plating is typically a multiple-stage chemical process where, for example, a thin copper layer is first deposited to form a conductive layer. This conductive layer is then used as an electrode for the subsequent plating of a thicker metal layer.

A typical metal deposition process for forming a metal layer onto the conductively doped resin-based material is vacuum metallization. Vacuum metallization is the process where a metal layer, such as aluminum, is deposited on the conductively doped resin-based material inside a vacuum chamber. In a metallic painting process, metal particles, such as silver, copper, or nickel, or the like, are dispersed in an acrylic, vinyl, epoxy, or urethane binder. Most resin-based materials accept and hold paint well, and automatic spraying systems apply coating with consistency. In addition, the excellent conductivity of the conductively doped resin-based material of the present invention facilitates the use of extremely efficient, electrostatic painting techniques.

The conductively doped resin-based materials can be contacted in any of several ways. In one embodiment, a pin is embedded into the conductively doped resin-based material by insert molding, ultrasonic welding, pressing, or other means. A connection with a metal wire can easily be made to this pin and results in excellent contact to the conductively doped resin-based material conductive matrix. In another embodiment, a hole is formed in to the conductively doped resin-based material either during the molding process or by a subsequent process step such as drilling, punching, or the like. A pin is then placed into the hole and is then ultrasonically welded to form a permanent mechanical and electrical contact. In yet another embodiment, a pin or a wire is soldered to the conductively doped resin-based material. In this case, a hole is formed in the conductively doped resin-based material either during the molding operation or by drilling, stamping, punching, or the like. A solderable layer is then formed in the hole. The solderable layer is preferably formed by metal plating. A conductor is placed into the hole and then mechanically and electrically bonded by point, wave, or reflow soldered.

Another method to provide connectivity to the conductively doped resin-based material is through the application of a solderable ink film to the surface. One exemplary solderable ink is a combination of copper and solder particles in an epoxy resin binder. The resulting mixture is an active, screen-printable and dispensable material. During curing, the solder reflows to coat and to connect the copper particles and to thereby form a cured surface that is directly solderable without the need for additional plating or other processing steps. Any solderable material may then be mechanically and/or electrically attached, via soldering, to the conductively doped resin-based material at the location of the applied solderable ink. Many other types of solderable inks can be used to provide this solderable surface onto the conductively doped resin-based material of the present invention. Another exemplary embodiment of a solderable ink is a mixture of one or more metal powder systems with a reactive organic medium. This type of ink material is converted to solderable pure metal during a low temperature cure without any organic binders or alloying elements.

A ferromagnetic conductively doped resin-based material may be formed of the present invention to create a magnetic or magnetizable form of the material. Ferromagnetic micron conductive fibers and/or ferromagnetic conductive powders are substantially homogenized with the base resin. Ferrite materials and/or rare earth magnetic materials are added as a conductive doping to the base resin. With the substantially homogeneous mixing of the ferromagnetic micron conductive fibers and/or micron conductive powders, the ferromagnetic conductively doped resin-based material is able to produce an excellent low cost, low weight, high aspect ratio magnetize-able item. The magnets and magnetic devices of the present invention can be magnetized during or after the molding process. Adjusting the doping levels and or dopants of ferromagnetic micron conductive fibers and/or ferromagnetic micron conductive powders that are homogenized within the base resin can control the magnetic strength of the magnets and magnetic devices. By increasing the aspect ratio of the ferromagnetic doping, the strength of the magnet or magnetic devices can be substantially increased. The substantially homogenous mixing of the conductive fibers/powders or in combinations there of allows for a substantial amount of dopants to be added to the base resin without causing the structural integrity of the item to decline mechanically. The ferromagnetic conductively doped resin-based magnets display outstanding physical properties of the base resin, including flexibility, moldability, strength, and resistance to environmental corrosion, along with superior magnetic ability. In addition, the unique ferromagnetic conductively doped resin-based material facilitates formation of items that exhibit superior thermal and electrical conductivity as well as magnetism.

A high aspect ratio magnet is easily achieved through the use of ferromagnetic conductive micron fiber or through the combination of ferromagnetic micron powder with conductive micron fiber. The use of micron conductive fiber allows for molding articles with a high aspect ratio of conductive fibers/powders or combinations there of in a cross sectional area. If a ferromagnetic micron fiber is used, then this high aspect ratio translates into a high quality magnetic article. Alternatively, if a ferromagnetic micron powder is combined with micron conductive fiber, then the magnetic effect of the powder is effectively spread throughout the molded article via the network of conductive fiber such that an effective high aspect ratio molded magnetic article is achieved. The ferromagnetic conductively doped resin-based material may be magnetized, after molding, by exposing the molded article to a strong magnetic field. Alternatively, a strong magnetic field may be used to magnetize the ferromagnetic conductively doped resin-based material during the molding process.

The ferromagnetic conductively doped is in the form of fiber, powder, or a combination of fiber and powder. The micron conductive powder may be metal fiber or metal plated fiber or powders. If metal plated fiber is used, then the core fiber is a platable material and may be metal or non-metal. Exemplary ferromagnetic conductive fiber materials include ferrite, or ceramic, materials as nickel zinc, manganese zinc, and combinations of iron, boron, and strontium, and the like. In addition, rare earth elements, such as neodymium and samarium, typified by neodymium-iron-boron, samarium-cobalt, and the like, are useful ferromagnetic conductive fiber materials. Exemplary ferromagnetic micron powder leached onto the conductive fibers include ferrite, or ceramic, materials as nickel zinc, manganese zinc, and combinations of iron, boron, and strontium, and the like. In addition, rare earth elements, such as neodymium and samarium, typified by neodymium-iron-boron, samarium-cobalt, and the like, are useful ferromagnetic conductive powder materials'. A ferromagnetic conductive doping may be combined with a non-ferromagnetic conductive doping to form a conductively doped resin-based material that combines excellent conductive qualities with magnetic capabilities.

### Method of Making the Capsules Described Herein

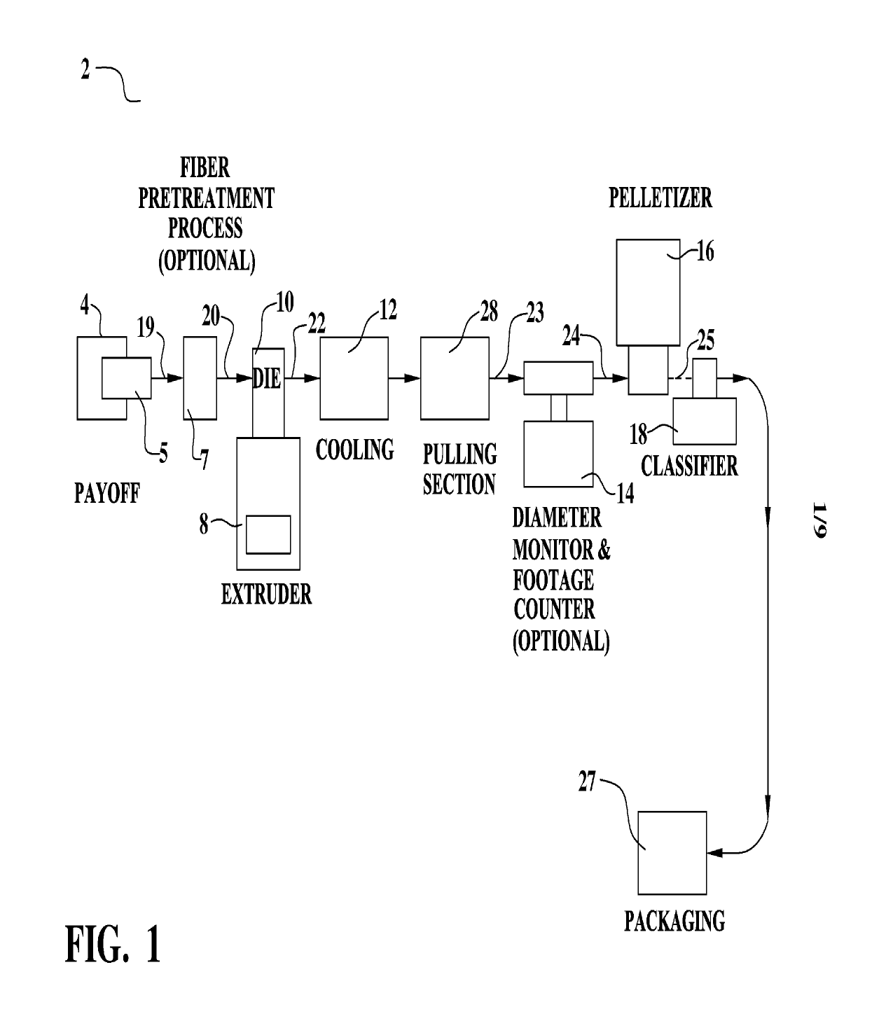

Referring now to FIG. 1, a first embodiment of the present invention is illustrated. A schematic 2 shows a manufacturing flow for forming a unique, moldable capsule via the present invention. In this emodiment, an extrusion/pultrusion process is used to extrude a base resin onto a continuous conductive micron fiber bundle. After extrusion/pultrusion, the combined fiber and resin cable or strand is pelletized into moldable capsules.

In the illustrated embodiment, a reel of micron conductive fiber 5 is loaded onto a payoff apparatus 4. The micron conductive fiber 19 preferably comprises multiple, parallel strands of micron conductive fiber. The bundle 19 preferably comprises up to tens of thousands of strands of fiber.

The micron conductive fiber bundle 19 is routed into the extrusion die 10. In some embodiments of the process, however, it is useful to pre-process the fiber bundle 19 prior to extrusion. A pretreatment process 7, or combination of processes, is performed to enhance the characteristics of the fiber bundle 19 prior to extrusion. Pretreatment processes include, but are not limited, leeching processes that add materials to the bundle and chemical modification processes that improve the fibers interfacial properties, and heating processes as further described below.

In one embodiment of a leeching pretreatment process 7, the micron conductive fiber 19 from the payoff reel 5 is first routed into a powdering apparatus 7 prior to routing into the extrusion apparatus 8 and 10. The powdering apparatus 7 preferably comprises a solution comprising micron conductive powder suspended in a liquid media. As the fiber bundle 19 is fed through the liquid media, the micron conductive powder in the solution leeches into the micron conductive fiber 19. The resulting treated fiber bundle 20 is thereby impregnated with micron conductive powder.

There are several embodiments of inert chemical modification processes that improve the fibers interfacial properties. Treatments include, but are not limited to, chemically inert coupling agents, gas plasma, anodizing, mercerization, peroxide treatment, benzoylation, and other chemical or polymer treatments. A chemically inert coupling agent is a material that is bonded onto the surface of metal fiber to provide an excellent coupling surface for later bonding with the resin-based material. This chemically inert coupling agent does not react with the resin-based material. An exemplary chemically inert coupling agent is silane. In a silane. treatment, silicon-based molecules from the silane molecularly bond to the surface of metal fibers to form a silicon layer. The silicon layer bonds well with the subsequently extruded resin-based material yet is chemically inert with respect to resin-based materials. The unpredictable and damaging chemical interactions exhibited in the prior art “salt and pepper” mix are thereby avoided. As an optional feature during a silane treatment, oxane bonds with any water molecules on the fiber surface to thereby eliminate water from the fiber strands. Silane, amino, and silane-amino are three exemplary pre-extrusion treatments for forming chemically inert coupling agents on the fiber.

In a gas plasma treatment, the surfaces of the metal fibers are etched at atomic depths to re-engineer the surface. Cold temperature gas plasma sources, such as oxygen and ammonia, are useful for performing a surface etch prior to extrusion. In one embodiment of the present invention, gas plasma treatment is first performed to etch the surfaces of the fiber strands. A silane bath coating is then performed to form a chemically inert silicon-based film onto the fiber strands. In another embodiment, metal fiber is anodized to form a metal oxide over the fiber. The fiber modification processes described herein are useful for improving interfacial adhesion, improving wetting during homogenization, and/or reducing and preventing oxide growth (when compared to non-treated fiber). Pretreatment fiber modification may also reduce levels of dust, fines, and fiber release during subsequent pellet cutting or vacuum fed feeders.

One embodiment of a method to form a moldable capsule comprises a fiber treatment process comprising providing a bundle of conductive fiber, and then heating the bundle before depositing a resin-based material onto the bundle to form a composite strand. After depositing a resin-based material onto the bundle to form a composite strand, the strand is sectioned into moldable capsules. It is believed that heating the bundle before depositing the resin-based material improves adhesion or “wetting” between the bundle and the resin-based material. This is believed to have several advantages including eliminating or reducing air gaps between the resin and bundle, and improving the cutting and pelletizing of the capsules, and also improving the performance of the capsule when used to make conductive articles. In some embodiments it is believed that by heating the bundle, the resin will not solidify on contact with the bundle, allowing the molten resin to better wet or adhere to the bundle, or to penetrate the bundle.

In one embodiment, heating comprises heating the bundle to a temperature near the melt temperature of the resin-based material, in some embodiments within 50° F. of the melt temperature. In another embodiment, heating comprises heating the bundle to a temperature above the melt temperature of the resin-based material, in some embodiments by as much as about 25° F., or about 50-100° F. over the melt temperature. In still another embodiment, heating comprises heating the bundle to a temperature above the glass transition temperature of the resin-based material, in some embodiments by as much as about 25° F., or about 50-100° F. over the glass transition temperature. In still further embodiments, heating comprises heating the bundle between ambient temperature and the glass transition temperature or the melt temperature. In still another embodiment, heating the bundle comprises heating the bundle to a temperature that allows the molten resin to wet or adhere to the bundle and/or allow the molten resin to penetrate the bundle.

In certain embodiments, heating the bundle before depositing or extruding the resin comprises routing the bundle through a heater before the bundle enters the area where the resin is deposited on the bundle, for example, a crosshead die. The heater may include a convection heater, a radiant heater, a conductive heater, and combinations of any thereof. Any method of heating suitable to heat the bundle to the desired temperature may be used. Once the bundle has been heated, resin is extruded or deposited on the bundle of fiber by pulling the bundle through a crosshead die or other means for depositing the resin on the bundle.

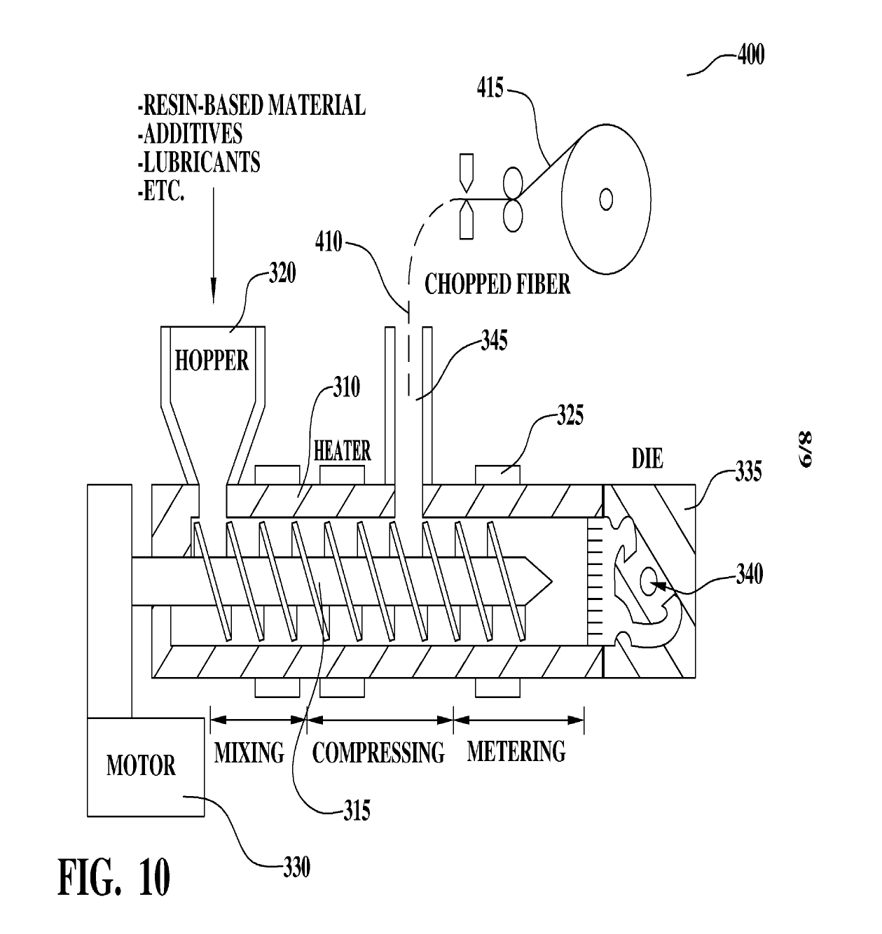

After the optional pretreatment, the treated micron fiber bundle 20 is routed into the extruder die 10. The extruder 8 and 10 is used to form or deposit resin-based material onto the fiber bundle 20. Several important features of the extruder 8 and 10 are described herein. Referring now to FIG. 9, an embodiment of the present invention is illustrated showing an extrusion machine, or extruder. The extruder comprises a hopper unit 320. Resin-based material is loaded into the hopper unit 320. In one embodiment, the resin-based material comprises pure resin-based material in the form of pellets, sheets, rods, or lumps. In other embodiments, various additives, lubricants, colorants, plasticizers, and other materials typical to the art of plastic molding are added to the resin-based material in the hopper 320. In yet other embodiments, micron conductive powders and/or fibers are added to the resin-based material in the hopper 320. In other embodiments, a pre-compounded resin-based material, where the resin-based material is pre-mixed with a combination of additives, lubricants, colorants, plasticizers, conductive powders and fibers, is loaded into the hopper 320. In another embodiment of the present invention, the resin-based hopper load is constantly fed at a rate to sustain high-volume extrusion of resin-based material onto the continuous fiber bundle 20. Any of a number of known material conveyances may be used, such as gravity feeders, vibratory feeders, and the like.

The hopper 320 feeds the resin-based material into a barrel 310 and screw 315 mechanism. The screw 315 is essentially a large auger that fits closely inside of the barrel 310. A motor 330 turns the screw 315 inside the barrel chamber 310 to create a combination material feeding, heating, and mixing effect. The barrel 310 is heated by this turning friction and by heaters 325 that are distributed around the barrel 310. The screw 315 and barrel 310 mechanism conveys the resin-based material away from the hopper 320 and toward the mold 335. In the mixing section of the screw 315 and barrel 310, the primarily actions are mixing and heating of the resin-based material. Melting begins to occur but without compression. In the subsequent compression section, the resin-based material is completely melted. Compression of the molten blend begins. In the subsequent metering section, the final mixing and homogenization of the resin-based material and all additives, lubricants, colorants, plasticizers, conductive fillers, and the like, is completed to generate physically homogenized material. The resin-based material is then forced through a crosshead die 335. In the crosshead die 335, the resin-based material converges and deposits on the micron fiber bundle 20. The micron conductive fiber bundle 20 is routed through the hollow core or ring 340 of the die 335 such that molten resin based material surrounds the bundle and is extruded onto the bundle as the bundle passes through.

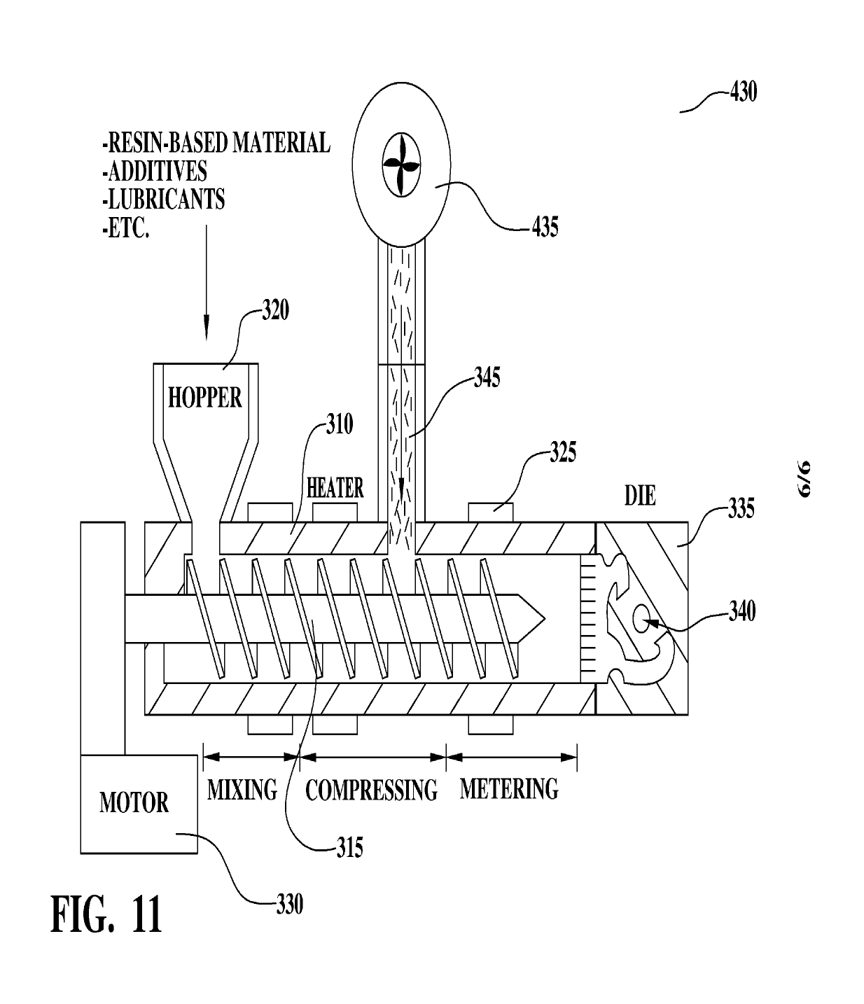

An optional down stage input 345 is shown on the extruder barrel 310. This additional material input is useful for adding components to the resin-based material after the main mixing and compressing sections of the barrel 310. Referring now to FIG. 10, an embodiment 400 of the present invention illustrates an embodiment where the down stage input is used. In this embodiment, the resin-based material is loaded into the hopper 320 as before. In this case, however, chopped micron conductive fiber 410 is added through the down stage input 345 to the resin-based material moving through the screw 315 and barrel 310. In this embodiment, a micron conductive fiber bundle 415, similar to that described for the main micron fiber bundle 20, is unwound from a spool and then chopped into specified lengths. The chopped fiber 410 becomes part of the resin-based material 20 that is routed into the crosshead die 335. It may be preferable to add chopped micron fiber, or other similar components, to the resin-based material in the screw 315 and barrel 310 after the primary mixing and compression stages to thereby minimize fiber damage due to mixing and compressing forces. In this embodiment, the chopped fiber 410 is added by gravity feed. This approach is well suited to adding conductive fiber such as metal or metal plated fiber to the moldable mixture.

Referring now to FIG. 11, a sixth embodiment 430 of the present invention shows another method to load fiber through the downstage input. In this embodiment, chopped fiber is blown into the screw 315 and barrel 310 mechanism through the down stage input 345 via a blowing or gun mechanism 435. This approach is well suited for loading fibers into the resin-based material. Again, by delaying the introduction of fibers until after primary mixing and compression, fiber damage is minimized.

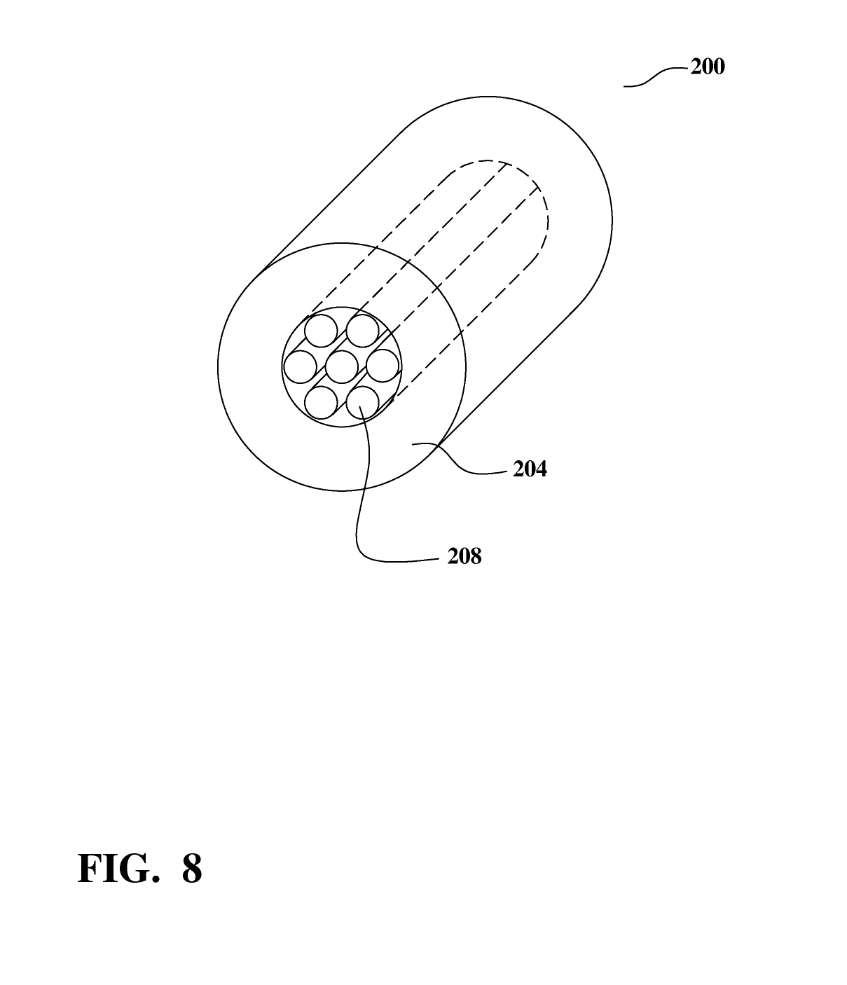

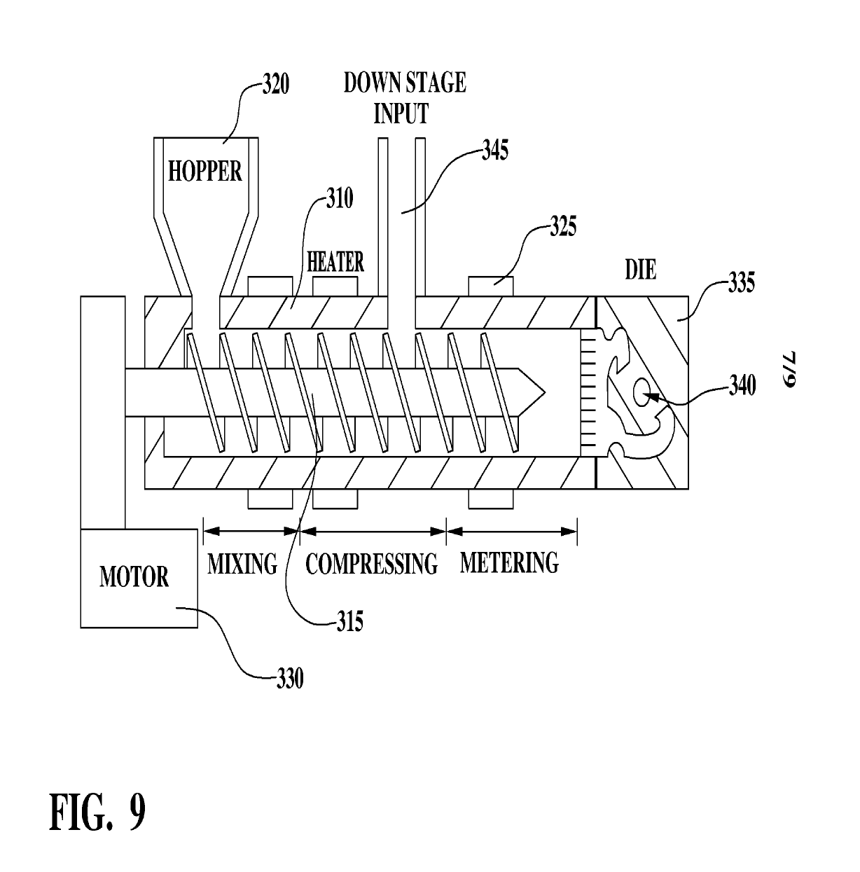

In another embodiment of the present invention, a twin screw extruder is used. A twin-screw extruder has two screws that are arranged side-by-side and rotate in an intermeshing pattern that typically looks like a “figure 8” in end view. The intermeshing action of the two screws constantly self-wipes the screw flights or inner barrel surfaces. A single screw extruder may exhibit difficulty with resin-based material adhering to the barrel sidewalls or flaking. However, a twin-screw extruder forces the resin-based material to follow the figure eight pattern and thereby generates a positive pumping action for all forms of resin-based material. As a result, a twin screw extruder is typically capable of operating at faster extrusion rates than a single screw extruder.

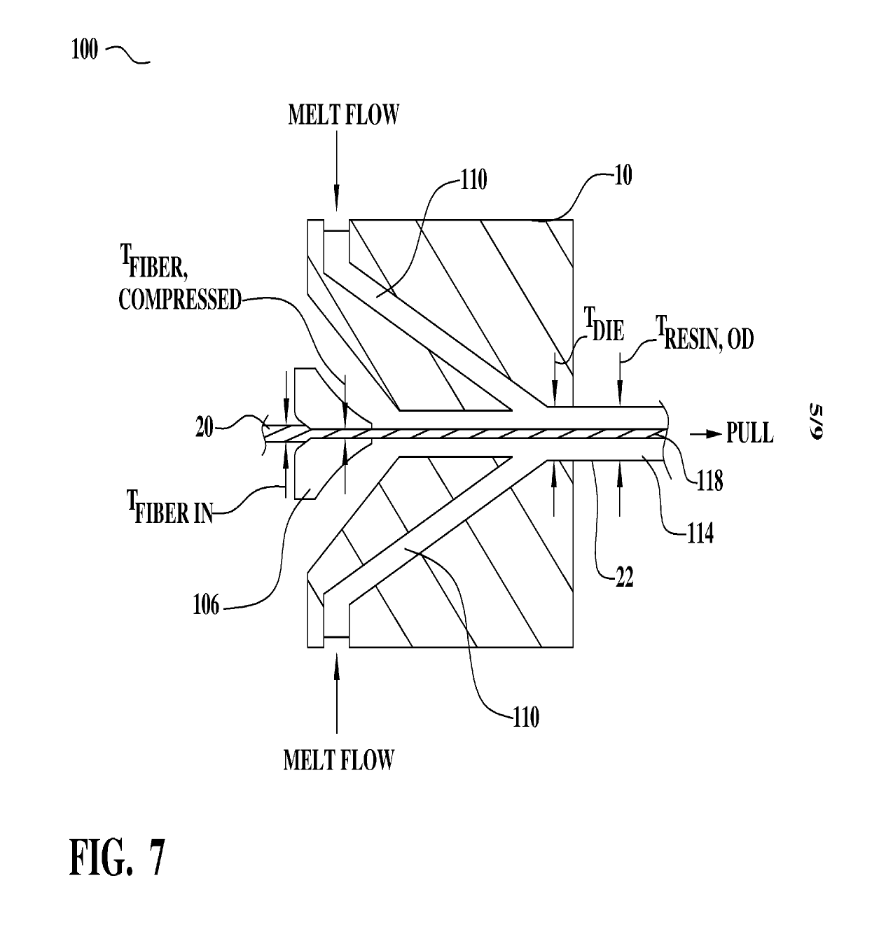

Referring now to FIG. 7, an embodiment of a crosshead die 10 of the present invention is illustrated in cross-sectional view. Several important features of the crosshead die and the method of extruding should be noted. An opening is made through the die 10 to allow the micron fiber bundle 20 to pass through. The bundle 20 passes routing channels containing the melted resin-based material 110.

The incoming fiber bundle 20 has a relatively thick diameter T_{FIBERIN}. Although each fiber strand is aligned in parallel, there may be air gaps between the strands. In one embodiment, prior to entering the crosshead die 10, the bundle 20 passes through a compression ring 106. The compression ring 106 progressively forces the fiber strands together and puts a compression force on the collective bundle. As a result, the outer diameter is reduced to T_{FIBER,COMPRESSED} as the compressed bundle 118 exits the compression ring 106. In other embodiments, the bundle id not compressed before entering the crosshead die.

By incorporating the step of compressing the fiber bundle 20, prior to extrusion coating with the molten resin-based material, several advantages are derived. First, the compression introduces an initial force onto the compressed bundle 118. After the resin-based material coats onto the compressed bundle 118, the fiber strands mechanically rebound against the resin-based material 114. This compression rebounding effectively locks together the fiber bundle 118 and the resin-based coating 114 in to what is herein called an extruded bundle 22. The compression/rebound effect is particularly important where a fiber material is selected that does not chemically bond well with the selected resin-based material. Second, during subsequent cutting, or pelletizing, of the extruded bundle, the compressed fiber 118 will be well-retained, or locked, in the resin-based outer covering 114. The fiber is also locked into the resin-based material during subsequent handling of the palletized, moldable capsules. This fiber retention mechanism is accomplished without coating the fiber bundle with a different resin-based material prior to extrusion. Therefore, additional processing expense is avoided and, more importantly, adverse interactions of dissimilar resin-based materials, as described in the prior art, are avoided. As an important additional advantage, it is found the moldable capsule formed using this pre-compressing process exhibits excellent fiber release during molding operations.

A controlled diameter of resin-based material 114 is extruded onto the compressed bundle 118. The resulting extruded cable diameter T_{RESIN,OD} is determined by the diameter of the die opening T_{DIE}. By controlling the extruded cable diameter T_{RESIN,OD}, and the speed of the process, a specified amount of resin-based material 114 is extruded onto the compressed bundle 118. As a result, the percent, by weight, of the micron conductive fiber 118 in the resulting extruded cable 22 is carefully controlled. More particularly, in one embodiment, the micron conductive fiber core 118 comprises between about 5% and about 50% of the total weight of the wire-like cable 22. In another embodiment, the micron conductive fiber core 118 comprises between about 20% and about 40% of the total weight of the wire-like cable 22. In a yet another embodiment, the micron conductive fiber core 118 comprises between about 25% and about 35% of the total weight of the wire-like cable 22. In a yet another embodiment, the micron conductive fiber core 118 comprises between about 10% and 20% of the total weight of the wire-like cable 22.

In another embodiment of the present invention, the conductive doping is determined by volume percentage. In one embodiment, the conductive doping comprises a volume of between about 4% and about 10% of the total volume of the conductively doped resin-based material. In another embodiment, the conductively doping comprises a volume of between about 1% and about 50% of the total volume of the conductively doped resin-based material though the properties of the base resin may be impacted by high percent volume doping.

The extrusion/pultrusion process produces a continuous extruded bundle or strand 22 comprising a micron fiber bundle 118 with a resin-based material 114 extruded or deposited thereon. In one embodiment, the micron fiber bundle 118 further comprises embedded micron conductive powder that is leeched into the bundle 118 prior to extrusion. In another embodiment, the micron fiber bundle 118 further comprises a chemically inert coupling agent to aid in bonding between fiber and resin-based material. In another embodiment, the micron fiber bundle has been anodized to prevent further oxidation effects on the fiber surface. In another embodiment, the micron fiber bundle has been etched to improve surface adhesion between fiber and resin-material. In another embodiment, the resin-based material further comprises conductive doping, such as micron conductive fiber or powder, such that the extruded bundle carries conductive doping both in the core bundle 118 and in the extruded covering 114.

Referring again to FIG. 1, the extruded bundle 22 passes through a cooling process 12. The cooling process reduces the temperature of the extruded bundle 22 by spraying with or immersing the bundle 22 in fluid such as water. The cooled extruded bundle 23 is pulled along by a pulling section 28. Preferably, the process 2 operates as a high-speed pulled-extrusion/pultrusion method similar to that used in the manufacture of conductive wiring. By pulling the cooled extruded bundle 23, the entire length of the micron conductive bundle is placed under tension. This tension allows the overall process to operate at high speeds without kinking or binding.

As an optional embodiment, the cooled extruded bundle 23 is processed through a control monitor 14 to verify the outer diameter of the cooled extruded bundle 23 and to count the overall length. The cooled extruded bundle 23 is then fed into a segmentation apparatus 16, or pelletizer, where the cooled extruded bundle 23 is segmented into individual moldable capsules 25. The moldable capsules 25 are, preferably segmented to a length L of between about 2 millimeters and about 14 millimeters although longer or shorter lengths may be used. The segmenting method may be by cutting, sawing, chopping, stamping, and the like. The moldable capsules 25 retain the same percent, by weight, of micron conductive material as the cooled extruded bundle 23. The segmented capsules 25 are processed through a classifier 18, separator, or screen, to remove any lose fiber, miss-cut pieces, tape, or other unwanted materials while retaining intact moldable capsules 25. Finally, the classified moldable capsules are packaged 27.

One embodiment of a method to form a moldable capsule comprises providing a bundle of conductive fiber, depositing a resin-based material onto the bundle to form a composite strand, performing a wetting process on the composite strand, and sectioning the composite strand into moldable capsules. In this embodiment, the wetting process is performed after the resin is extruded or deposited onto the bundle, for example, in the crosshead die. Once again, it is believed that the wetting process improves adhesion or “wetting” between the bundle and the resin-based material. This is believed to have several advantages including eliminating or reducing air gaps between the resin and bundle, and improving the cutting and pelletizing of the capsules, and improving the performance of the capsules when used to make a conductive article.

In some embodiments, this wetting process comprises exerting a force on the outside of the strand. In one embodiment, exerting the force comprises using at least one roller or a series of rollers. The strand is pulled through at least one roller or set of rollers, exerting force on the outside of the strand, which in turn exerts a force on the interior fiber bundle. It is believed that the force exerted by the resin on the bundle improves wetting between the resin and bundle of fiber. Any other suitable means for exerting a force on the bundle may be used, including belts, pulleys, rings, air pressure, hydraulic pressure, and the like.

In certain embodiments, if the strand is too hot before pressure is exerted, the resin could deform and detach from the strand. Therefore, in some embodiments, the strand is cooled before exerting the force. In other embodiments, an outer portion of the strand is cooled to a temperature below the melting point before exerting the force. In other embodiments, an outer portion of the strand is cooled to a temperature near the glass transition temperature before exerting a force. In further embodiments, an outer portion of the strand is cooled to a temperature below the glass transition temperature before exerting the force. In still further embodiments, the strand is cooled such that a secondary portion of the capsule between the outer portion and the bundle is at a temperature wherein the resin in the secondary portion will flow under the force when the force is exerted, for example, by a roller. In this embodiment, the outside of the strand must be cooled enough to ensure that exerting a force does not destroy the strand, but not so much that the secondary portion is not able to wet the fiber bundle when forced against it.

Any method of cooling may be used to cool the strand before exerting a force and/or cutting. For example, a water bath, water spray, water mist, vortex coolers, and any other suitable method of cooling.

In certain embodiments, exerting a force and sectioning the strand into capsules are performed in substantially the same operation. For example, the strand may be sectioned using a stamping operation. The stamping mechanism may be designed such that when the stamp is lowered, it not only cuts one or more capsules from the strand, but also exerts a force on parts of the capsules in between the cuts.

In embodiments where a force is exerted on the outside of the strand, the capsule and the inner fiber bundle may take a non-circular profile. In other words, exerting force by rollers, belts, or stamping may force the strand from a substantially circular profile as in FIG. 8 to a non-circular profile. The resulting capsules will include an inner bundle of conductive fiber, and an outer layer of resin, wherein either one or both of the capsule and inner fiber bundle comprise a non-circular profile. The non-circular profile may be substantially oval, substantially rectangular, or any other shape as a result of the method of applying the force. In other words, the strand and resulting capsules may be flattened more like a “ribbon,” with longer flattened sides and shorter curved ends. In some embodiments, these capsules may be approximately 10 mm in length (in the direction of the fiber), 1-2 mm thick (the shorter dimension of a cross-section), and 3-4 mm wide (the longer dimension of the cross-section). In some embodiments, the shape of the inner bundle may differ from the shape of the capsule. The non-circular profile of the bundle may be substantially oval, substantially rectangular, or substantially a “figure-eight” shape. The figure-eight shape may approximate the shape of an “8,” or the two lobes of the “8” may even separate slightly, or in some embodiments the fiber may actually form two discrete bundles, each bundle having a substantially circular or non-circular shate. It is believed that these varying configurations of the capsule and bundle have the unexpected benefit of improving fiber release and distribution when the capsules are processed to form an article, for example in an extruder or injection molder.

### The Capsule

Referring now to FIG. 8, an embodiment of a moldable capsule 200 of the present invention is illustrated. Several important features of the present invention are shown and are discussed below. This moldable capsule 200 comprises a micron conductive fiber bundle core 208 with a resin-based material 204 extruded or deposited thereon. Note that this figure is not to scale, but is drawn to illustrate the location and arrangement of the resin and fiber. According to various embodiments, the micron conductive fiber core 208 comprises micron conductive fiber, micron conductive powder, or a combination of micron conductive fiber and powder. The resin-based material 204 preferably comprises a single resin-based polymer material that is moldable. A number of specific resin-based materials 204 useful for this embodiment are described herein. According to other embodiments, the resin-based material 204 further comprises additives, lubricants, colorants, plasticizers, micron conductive fibers and powders, in any combination.

In one embodiment, the moldable capsule 200 preferably comprises a cylindrical or somewhat cylindrical shape. That is, the moldable capsule 200 of the embodiment has a definite length L. The moldable capsule 200 preferably comprises a length L of between about 2 millimeters and about 14 millimeters although longer or shorter lengths may be used. Further, the moldable capsule has a generally circular cross section. However, other cross sectional shapes may be used, such as rectangular, polygonal, or even amorphous. In one embodiment, the core 208 comprises a circular cross section as is common to wire. In another embodiment, the core 208 comprises a square or a rectangular cross section. In yet another embodiment, the core 208 comprises a ribbon-like cross section. The resin-based material 204 surrounds or encases the core 208 along the longitudinal axis. In addition, the resin-based material 204 may permeate the fiber core 208. The core 208 may be exposed at the ends of the moldable capsule 200. This embodiment 200 of the present invention is consistent with the method of formation by extrusion/pultrusion and sectioning as is described herein.

The percentage, by weight, of the conductive element core 208 of the moldable capsule 200 is carefully controlled. More particularly, in one embodiment, the fiber core 208 comprises between about 5% and about 50% of the total weight of the capsule. In another embodiment, the conductive element core 208 comprises between about 20% and about 40% of the total weight of the capsule. In a yet another embodiment, the fiber core 208 comprises between about 25% and about 35% of the total weight of the capsule. In a yet another embodiment, the conductive element core 18 comprises between about 10$ and 20% of the total weight of the capsule.

By carefully controlling the percentage, by weight, of the fiber core 208 in the moldable capsule 200 within the above-described ranges, the present invention creates a novel moldable capsule 200. This moldable capsule 200 has a unique formulation and exhibits several exceptional and unexpected features not found in the prior art. The moldable capsule 200 of the present invention utilizes a much smaller percentage, by weight, of conductive doping than the concentrate pellets of the prior art. The novel formulation of the moldable capsule 200 of the present invention results in a moldable capsule 200 that can be directly molded to form articles without mixing with a pure, or non-loaded pellet as in the prior art. By substantially reducing the conductive doping in the conductive element core 208, the relative amount of resin-based material 204 available for molding is increased. It is found that the formulation of the present invention contains sufficient resin-based material for excellent moldability without the addition of “pure” plastic pellets. This feature reduces manufacturing part count and complexity while eliminating the inter-plastic mismatching, bonding problems, non-homogeneous mixture tendencies, and potentially dangerous chemical interactions found in the prior art. The novel formulation of the present invention insures that articles molded have sufficient resin-based material from the moldable capsule alone to exhibit excellent physical, structural, and chemical properties inherent in the base resin.

Further, the moldable capsule 200 of the present invention further provides an optimal concentration of conductive doping to achieve high electrical conductivity and exceptional performance characteristics within the EMF or electronics spectrum(s) for many applications including antenna applications and/or EMI/RFI absorption applications. The formulation also results in excellent thermal conductivity, acoustical performance, and mechanical performance of molded articles. The formulation creates a conductively doped composition and a doping concentration that creates an exceptional conductive network in the molded article. The novel formulation insures that the resulting molded article achieves sufficient conductive doping from the moldable capsule, alone, to exhibit excellent electrical, thermal, acoustical, mechanical, and electromagnetic properties from a well-formed conductive network within the resin-based polymer matrix.

Further, the formulation of the present invention creates a moldable capsule 200 exhibiting an optimal, time release capability. The moldable capsule 200 incorporates a relatively large amount of resin-based material 204 extruded onto and permeating into the micron conductive fiber core 208. The greater amount, by weight, of resin-based material 204, when compared to the prior art, results in a larger volume of resin-based material that must melt in the mixing and compression section of an extruder prior to fiber release. As a result, an optimal time release property is achieved. The inner micron conductive fiber is dispensed and dispersed into the melted composite mixture at the right time and place in the mixing/molding cycle to minimize extruder induced damage to the fiber. Therefore, the moldable capsules can be mixed, melted, and substantially homogeneous more easily without damaging the fiber doping. Problems of non-homogenous mixing, fiber damage, fiber clumping, ganging, balling, swirling, hot spots and mechanical failures are eliminated.

The embodiment comprising pre-compression of the micron conductive fiber of the moldable capsule further facilitates excellent release of the fiber from the resin-based material during melting and mixing. The release, or separation, of the fiber strands of conductive element(s) 208 from the outer, resin-based material 204 is a critical stage in preparing a conductively doped, resin-based material for molding. The release and substantial homogenization of fiber and polymer affects not only the structural integrity of the molded conductively doped resin-based material, but also affects material conductivity. If the fiber separation is too fast, as in the prior art, the fiber will experience undo breakage, disruptive orientation, and will not be homogenized with the base resin evenly. These detrimental effects are due to the combination of high rotation speed of the screw, barrel friction, nozzle design and other pressures or forces exerted on the materials during mixing, melting, and compression prior to injection into a die or mold. The novel formulation of the moldable capsules 200 of the present invention controls the timing sequence and the orientation for the fiber 208 release cycle to thereby accurately and evenly dispense the conductive elements within the base resin. As a result, an excellent conductive network is substantially homogeneously formed in the molded article.

Further, the formulation of the moldable capsule 200 of the present invention is very well suited for use with a micron conductive fiber core 208 comprising micron conductive fibers. The orientation of the micron conductive fibers, such as random, omni-directional, or parallel, in the molded conductively doped resin-based article can significantly affect the performance of the article. As is known in the art, mold design, gating, protrusion designs, or other means within the molding apparatus, may be used to control the orientation of dopant materials incorporated into a resin-based material. The timed-release moldable capsules 200 of the present invention are particularly useful in facilitating the ability to control fiber directionality due to the ease with which initial homogenization occurs without over-mixing.

Further, the formulation of the moldable capsule 200 of the present invention provides a homogeneously mixed composite material of conductive elements and base resin that is optimized to maximize molecular interaction between the base resin polymer and the conductive elements. Equalization and intertwining of the network of conductive elements with the base resin molecular chains results in enhanced molecular properties in the base resin polymer chain including physical, electrical, and other desirable properties.

The conductive fiber of the present invention creates a high aspect ratio conductive element such that individual fiber elements easily overlap with each other. As a result, the conductive lattice exhibits electron exchange capability on par with low resistance, pure metals such as copper. By comparison, conductive powders present essentially no aspect ratio for overlapping. Therefore, a very high conductive powder doping must be used to generate a low resistance molded material. However, this doping must be so large that it disrupts the resin polymer chain structures and results in a molded part with very poor structural performance. Conductive flakes present a better aspect ratio than powders but still do not provide the combined low resistance and sound structural performance found in the present invention.

Further, the formulation of the moldable capsule 200 of the present invention is compatible with, and extendable in scope to, micron conductive fiber core 208 comprises a variety of micron conductive fibers, a variety of micron conductive powders, and a variety of combinations of micron conductive fibers and/or powders. The micron conductor fibers each have a diameter of between about 3 microns and 12 microns, and typically in the range of between about 6 and 12 microns. The overall bundle, or cord, comprises many individual fiber strands routed together in parallel. Hundreds, thousands, or tens of thousands of fibers are thus routed to form the cord. The length of the conductive element core corresponds roughly to the length of the moldable capsule since a common segmentation step cuts through both the conductive element core and the outer resin-based material.

The conductive element core 208 comprises conductive fiber and/or conductive powder. In one embodiment of the present invention, the conductive fiber and/or conductive powder comprise metal material. More particular to the present invention, this metal material is preferably in any form of, but not limited to, pure metal, combinations of metals, metal alloys, metal-clad onto other metal, and the like. More particular to the present invention, this metal material is combined with the resin-based material using an extrusion/pultrusion method as illustrated herein in FIGS. 1, 7, and 9-11. As is described in these embodiments, the conductive element core preferably begins as a bundle of very fine wire called a micron fiber bundle. The resin-based material is extruded onto this micron fiber bundle and then segmented to form the novel molding capsules of the present invention.

There are numerous metal materials that can be used to form the micron fiber bundle according to the present invention. An exemplary list of micron wire materials includes:
(1) copper, alloys of copper such as coppered alloyed with any combination of beryllium, cobalt, zinc, lead, silicon, cadmium, nickel, iron, tin, chromium, phosphorous, and/or zirconium, and copper clad in another metal such as nickel;
(2) aluminum and alloys of aluminum such as aluminum alloyed with any combination of copper, magnesium, manganese, silicon, and/or chromium;
(3) nickel and alloys of nickel including nickel alloyed with any combination of aluminum, titanium, iron, manganese, and/or copper;
(4) precious metals and alloys of precious metals including gold, palladium, platinum, platinum, iridium, rhodium, and/or silver;
(5) glass ceiling alloys such as alloys of iron and nickel, iron and nickel alloy cores with copper cladding, and alloys of nickel, cobalt, and iron;
(6) refractory metals and alloys of refractory metals such as molybdenum, tantalum, titanium, and/or tungsten;
(7) resistive alloys comprising any combination of copper, manganese, nickel, iron, chromium, aluminum, and/or iron;
(8) specialized alloys comprising any of combination of nickel, iron, chromium, titanium, silicon, copper clad steel, zinc, and/or zirconium;
(9) spring wire formulations comprising alloys of any combination of cobalt, chromium, nickel, molybdenum, iron, niobium, tantalum, titanium, and/or manganese;
(10) stainless steel comprising alloys of iron and any combination of nickel, chromium, manganese, and/or silicon;
(11) thermocouple wire formulations comprising alloys of any combination of nickel, aluminum, manganese, chromium, copper, and/or iron

Within this embodiment wherein the conductively doped material comprises a micron wire bundle, it is common to specify this type of material in terms of feet per pound. It is relatively straightforward to convert the desired percent by weight, of the conductive doping into the feet per pound regime. When the micron wire bundle is encapsulated in the resin-based material, yet prior to segmentation, the combined micron wire bundle and base resin combination bears a combined feet per pound (X_{Total}). The original feet per pound of the micron wire bundle only (X_{wire}) should be known. By inverting these quantities, the weight per foot of each can be derived as 1/X_{Total} and 1/X_{wire}. The desired percent weight of conductive doping can then be selected according to:

Percent weight=(1/X_{wire})/(1/X_{Tota}).

Referring again to FIG. 8, in another embodiment, the conductive element core 208 comprises a combination of micron conductive fiber and micron conductive powder. A number of specific micron conductive fibers and micron conductive powders useful for this embodiment are described herein. Again, the micron conductive fiber preferably comprises a bundle, or cord, of fibers stacked or routed in parallel or twisted around a central axis. In the illustration, a few such micron conductive fibers are shown. In practice, hundreds, or tens of thousands of fibers are used to create a bundle or cord. If combined with a cord of micron conductive fibers, the micron conductive powder is preferably leeched into the cord of fibers as is described above. The micron conductive powder, along with the micron conductive fiber, acts as a conductor in the conductive network of the resulting molded article. In this case, the percentage, by weight, of the combined micron conductive fiber and micron conductive powder in the moldable capsule is formulated and controlled within the ranges herein described. In addition, the micron conductive powder may act as a lubricant in the molding machine.

As another embodiment, the resin-based material 204 is further loaded with micron conductive powder as described in the method above. Again, the micron conductive fiber 208 in the core preferably comprises a bundle, or cord, of fibers stacked or routed in parallel or twisted around a central axis. In the illustration, a few such micron conductive fibers are shown. In practice, hundreds, or tens of thousands of fiber strands are used to create a bundle or cord. The micron conductive powder in the resin-based material 204 is released when the resin-based material 204 melts. The micron conductive powder acts as a conductor, along with the micron conductive fiber 208, in the conductive network of the resulting molded article. Again, the percentage, by weight, of the combined micron conductive fiber 208 and micron conductive powder in the moldable capsule 200 is formulated and controlled within the ranges herein described. In addition, the micron conductive powder may act as a lubricant in the molding machine.

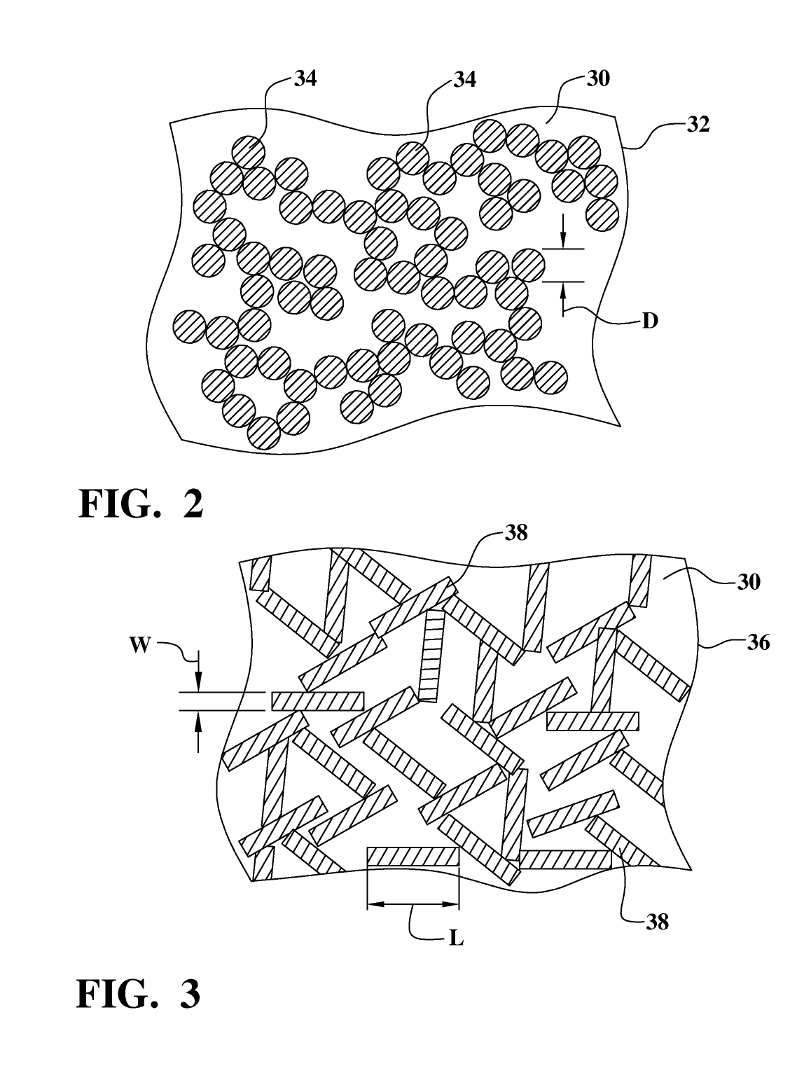

The several embodiments of moldable capsules according to the present invention are easily molded into manufactured articles by injection molding, extrusion molding, compression molding and the like. The resulting molded articles comprise an optimal, conductively doped resin-based material. This conductively doped resin-based material typically comprises a micron powder(s) of conductor particles and/or in combination of micron fiber(s) substantially homogenized within a base resin host. FIG. 2 shows a cross section view of an example of conductively doped resin-based material 32 having powder of conductor particles 34 in a base resin host 30. In this example the diameter D of the conductor particles 34 in the powder is between about 3 and 12 microns.

### Articles Made From the Capsules Described Herein

FIG. 3 shows a cross section view of an example of conductively doped resin-based material 36 having conductor fibers 38 in a base resin host 30. The conductor fibers 38 have a diameter of between about 3 and 12 microns, typically in the range of 10 microns or between about 8 and 12 microns, and a length of between about 2 and 14 millimeters. The micron conductive fibers 38 may be metal fiber or metal plated fiber. Further, the metal plated fiber may be formed by plating metal onto a metal fiber or by plating metal onto a non-metal fiber. Exemplary metal fibers include, but are not limited to, stainless steel fiber, copper fiber, nickel fiber, silver fiber, aluminum fiber, nichrome fiber, or the like, or combinations thereof. Exemplary metal plating materials include, but are not limited to, copper, nickel, cobalt, silver, gold, palladium, platinum, ruthenium, rhodium, and nichrome, and alloys of thereof. Any platable fiber may be used as the core for a non-metal fiber. Exemplary non-metal fibers include, but are not limited to, carbon, graphite, polyester, basalt, man-made and naturally-occurring materials, and the like. In addition, superconductor metals, such as titanium, nickel, niobium, and zirconium, and alloys of titanium, nickel, niobium, and zirconium may also be used as micron conductive fibers and/or as metal plating onto fibers in the present invention.

These conductor particles and/or fibers are substantially homogenized within a base resin. As previously mentioned, the conductively doped resin-based materials have a sheet resistance of less than about 5 to more than about 25 ohms per square, though other values can be achieved by varying the doping parameters and/or resin selection. To realize this sheet resistance the weight of the conductor material comprises between about 1% and about 50% of the total weight of the conductively doped resin-based material. In other embodiments, the weight of the conductive material comprises between about 5% and 40%. In other embodiments, the weight of the conductive material comprises between about 10% and about 30% of the total weight of the conductively doped resin-based material. In yet another embodiment, the weight of the conductive material comprises between about 25% and about 35% of the total weight of the conductively doped resin-based material. In still another embodiment, the weight of the conductive material comprises about 10% to 20% of the total weight of the conductively doped resin-based material. In still another embodiment, the weight of the conductive material comprises about 5% to 20% of the total weight of the conductively doped resin-based material. Stainless Steel Fiber of 6-12 micron in diameter and lengths of 4-6 mm and comprising, by weight, about 30% of the total weight of the conductively doped resin-based material will produce a very highly conductive parameter, efficient within any EMF, thermal, acoustic, or electronic spectrum.

In yet another embodiment of the present invention, the conductive doping is determined using a volume percentage. In a embodiment, the conductive doping comprises a volume of between about 4% and about 10% of the total volume of the conductively doped resin-based material. In an embodiment, the conductive doping comprises a volume of between about 1% and about 50% of the total volume of the conductively doped resin-based material though the properties of the base resin may be impacted by high percent volume doping.

Referring now to FIG. 4, another embodiment of the present invention is illustrated where the conductive materials comprise a combination of both conductive powders 34 and micron conductive fibers 38 substantially homogenized together within the resin base 30 during a molding process.

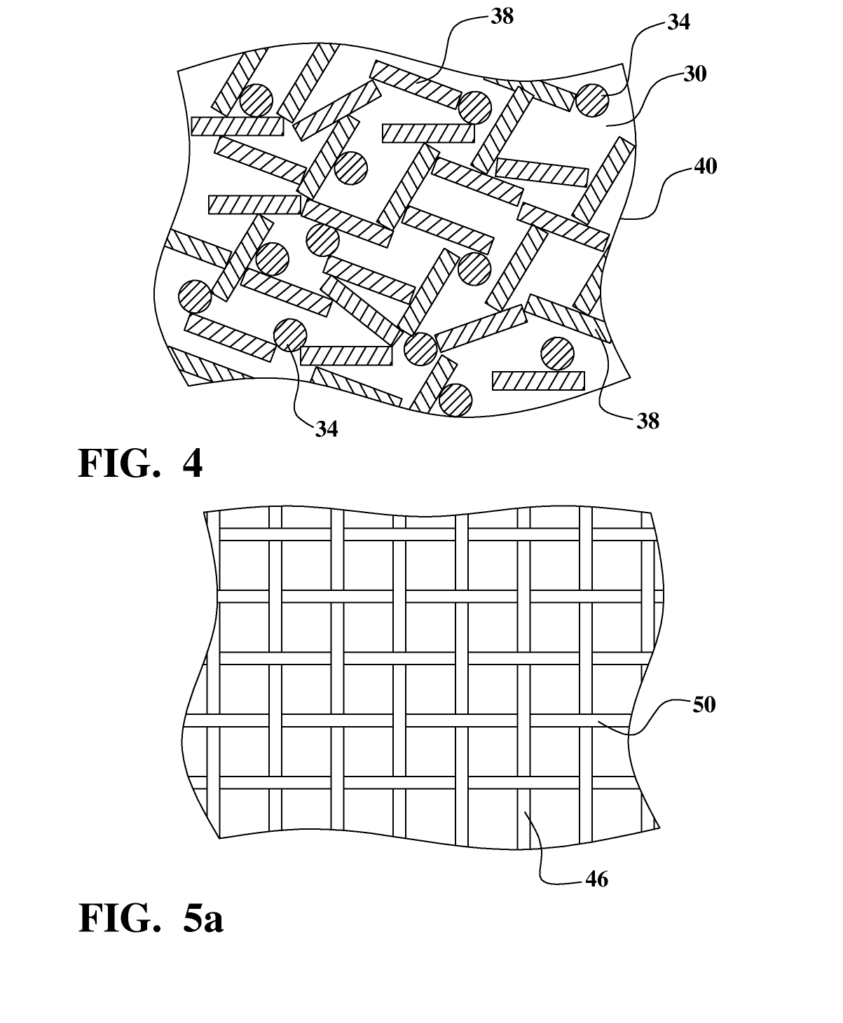

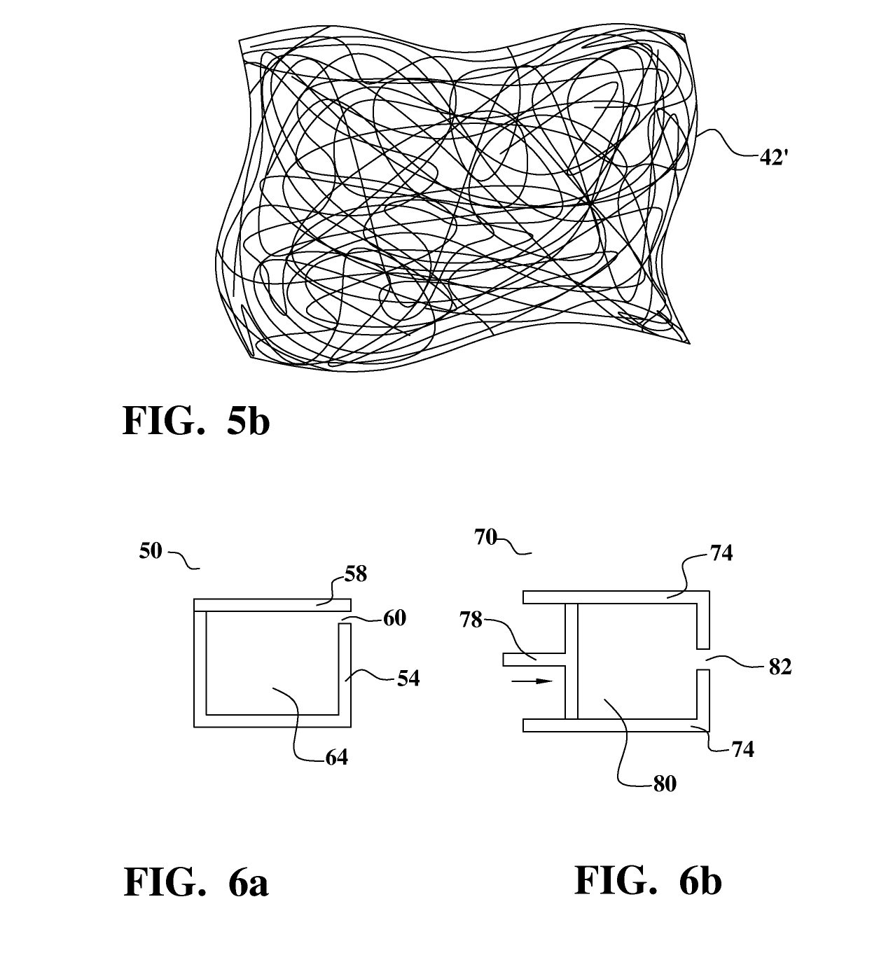

Referring now to FIGS. 5a and 5b, a composition of the conductively doped, resin-based material is illustrated. The conductively doped resin-based material can be formed into fibers or textiles that are then woven or webbed into a conductive fabric. The conductively doped resin-based material is formed in strands that can be woven as shown. FIG. 5a shows a conductive fabric 42 where the fibers are woven together in a two-dimensional weave 46 and 50 of fibers or textiles. FIG. 5b shows a conductive fabric 42′ where the fibers are formed in a webbed arrangement. In the webbed arrangement, one or more continuous strands of the conductive fiber are nested in a random fashion. The resulting conductive fabrics or textiles 42, see FIG. 5a, and 42′, see FIG. 5b, can be made very thin, thick, rigid, flexible or in solid form(s).

Similarly, a conductive, but cloth-like, material can be formed using woven or webbed micron stainless steel fibers, or other micron conductive fibers. These woven or webbed conductive cloths could also be sandwich laminated to one or more layers of materials such as Polyester(s), Teflon(s), Kevlar(s) or any other desired resin-based material(s). This conductive fabric may then be cut into desired shapes and sizes.

Articles formed from conductively doped resin-based materials can be formed or molded in a number of different ways including injection molding, extrusion, calendaring, compression molding, thermoset molding, or chemically induced molding or forming. FIG. 6a shows a simplified schematic diagram of an injection mold showing a lower portion 54 and upper portion 58 of the mold 50. Conductively doped resin-based material is injected into the mold cavity 64 through an injection opening 60 and then the substantially homogenized conductive material cures by thermal reaction. The upper portion 58 and lower portion 54 of the mold are then separated or parted and the articles are removed.

FIG. 6b shows a simplified schematic diagram of an extruder 70 for forming articles using extrusion. Conductively doped resin-based material(s) is placed in the hopper 80 of the extrusion unit 74. A piston, screw, press or other means 78 is then used to force thermally molten, chemically-induced compression, or thermoset curing conductively doped resin-based material through an extrusion opening 82 which shapes the thermally molten curing or chemically induced cured conductively doped resin-based material to the desired shape. The conductively doped resin-based material is then fully cured by chemical reaction or thermal reaction to a hardened or pliable state and is ready for use. Thermoplastic or thermosetting resin-based materials and associated processes may be used in molding the conductively doped resin-based articles of the present invention.

### Example 1

In one embodiment, a fiber bundle of nickel-plated carbon fiber was unspooled and routed through a heater. The heater comprised a tube with heated air being pumped into the tube. Upon exiting the tube, the fiber bundle was approximately 250° F. before entering a crosshead die where a thermoplastic ABS resin was deposited on the bundle.

### Example 2

In one embodiment, a fiber bundle of nickel-plated carbon fiber was routed through a crosshead die where a thermoplastic ABS resin was deposited on the fiber bundle. After exiting the crosshead die, the strand was sprayed with a water mist. The water mist evaporated on the surface of the strand, cooling the outer layer of the strand. In one embodiment, force was exerted on the strand by being routed between two rollers and then cut by a pelletizer, creating pellets that were about 9.98 mm long, 4.5 mm wide (longer measurement of the cross section) and 1.53 mm thick (shorter measurement of the cross section).

In another embodiment, the strand was routed between two puller belts instead of two rollers, creating pellets that were about 9.99 mm long, 3.63 mm wide (longer measurement of the cross section) and 1.9 mm thick (shorter measurement of the cross section).

In certain of these embodiments, some of the capsules had a substantially flat shape with rounded edges. In some embodiments, the fiber bundle took on the same shape. In other embodiments, the fiber bundle had a “tear drop” shape. In still other embodiments, the fiber bundle had an “i” shape, with a thin elongated portion just barely separated from a small bundle of fiber. In still other embodiments, the fiber bundle formed a “figure 8” shape. In these embodiments, some of the “lobes” of the “8” were touching, and in other embodiments they were slightly separated.

The present invention may be embodied in other specific forms without departing from its essential characteristics. The described embodiments are to be considered in all respects only as illustrative and not as restrictive. The scope of the present invention is, therefore, indicated by the appended claims rather than by the foregoing description. All changes which come within the meaning and range of the equivalence of the claims are to be embraced within their scope.

1. A method to form a moldable capsule comprising:
providing a bundle of conductive fiber;
heating the bundle;
depositing a resin-based material onto the bundle to form a composite strand; and
sectioning the composite strand into moldable capsules.

2. The method of claim 1 wherein heating comprises heating the bundle to a temperature near the melt temperature of the resin-based material.

3. The method of claim 2 wherein heating comprises heating the bundle to a temperature above the melt temperature of the resin-based material.

4. The method of claim 1 wherein heating comprises heating the bundle to a temperature above the glass transition temperature of the resin-based material.

5. The method of claim 1 wherein heating further comprises routing the bundle through a heater.

6. The method of claim 5, where the heater is selected from the group consisting of a convection heater, a radiant heater, a conductive heater, and combinations of any thereof.

7. The method of claim 1 wherein depositing comprises pulling the bundle through a crosshead die.

8. The method of claim 1 wherein the resin-based material comprises a substantially homogeneous mixture of a micron conductive material.

9. The method of claim 1, wherein the conductive fiber is a micron conductive fiber.

10. The method of claim 9 wherein the micron conductive fiber comprises between about 5% and about 50% of the total weight of each of the moldable capsules.

11. The method of claim 9 wherein the micron conductive fiber comprises a material selected from the group consisting of a metal or metal alloy, a non-conductive inner core material with outer conductive plating, a ferromagnetic material, and combinations of any thereof.

12. The method of claim 9 wherein the micron fiber has a diameter of approximately 3 to 12 microns and a length of approximately 2 to 14 mm.

13. A method to form a moldable capsule comprising:
providing a bundle of conductive fiber;
depositing a resin-based material onto the bundle to form a composite strand;
performing a wetting process on the composite strand; and
sectioning the composite strand into moldable capsules.

14. The method of claim 13 wherein performing a wetting process comprises exerting a force on the outside of the strand.

15. The method of claim 14 wherein exerting the force comprises applying force by at least one roller.

16. The method of claim 14, wherein the strand is cooled before exerting the force.

17. The method of claim 16, wherein an outer portion of the strand is cooled to a temperature below the melting point of the resin before exerting the force.

18. The method of claim 16, wherein an outer portion of the strand is cooled to a temperature near the glass transition temperature before exerting a force.

19. The method of claim 16, wherein an outer portion of the strand is cooled to a temperature below the glass transition temperature before exerting the force.

20. The method of claim 17, wherein a secondary portion of the capsule between the outer portion and the bundle is at a temperature wherein the resin in the secondary portion will flow under the force when exerting the force.

21. The method of claim 13 wherein depositing comprises pulling the bundle through a cross-head die.

22. The method of claim 13 further comprising heating the bundle prior to the step of depositing.

23. The method of claim 14, wherein exerting a force and sectioning are performed in substantially the same operation.

24. The method of claim 13, where the conductive fiber is a micron conductive fiber.

25. The method of claim 24 wherein the micron conductive fiber comprises between about 5% and about 50% of the total weight of each the moldable capsule.

26. The method of claim 24 wherein the micron conductive fiber comprises a material selected from the group consisting of a metal or metal alloy, a non-conductive inner core material with outer conductive plating, a ferromagnetic material, and combinations of any thereof.

27. The method of claim 24 wherein the micron fiber has a diameter of approximately 3 to 12 microns and a length of approximately 2 to 14 mm.

28.-32. (canceled)
